(19) United States
(12) Patent Application Publication
(10) Pub. No.: US 2014/0290626 A1
(43) Pub. Date: Oct. 2, 2014

(54) ASSEMBLING FUEL PUMP ON ENGINE

(71) Applicant: CATERPILLAR INC., Peoria, IL (US)

(72) Inventors: Christopher R. Jones, Washington, IL (US); Andrew D. Rockwell, East Peoria, IL (US)

(73) Assignee: Caterpillar Inc., Peoria, IL (US)

(21) Appl. No.: 13/852,092

(22) Filed: Mar. 28, 2013

(51) Int. Cl. F02M 39/02

(52) U.S. Cl. CPC F02M 39/02
USPC 123/508; 29/888

(57) ABSTRACT

A method of assembling a fuel pump on an engine is disclosed. The method includes a timing pin installed between a pump flange of the fuel pump and a flywheel housing of the engine. The pump flange is moved towards the flywheel housing. The timing pin is further removed which is installed between the pump flange and the flywheel housing of the engine. Further, the pump flange is abutted with the flywheel housing of the engine.

### TECHNICAL FIELD

The present disclosure relates generally to a fuel pump for an engine and more particularly relates to a method of assembling the fuel pump on the engine.

### BACKGROUND

In a common rail fuel injection system, it is typically necessary to time a fuel pump with relatively great precision relative to a timing of the engine to maintain or control common rail pressure which is further configured to supply pressurized fuel into the engine. When an internal combustion engine system is assembled and set up for initial service, an appropriate timing between the engine and the fuel pump for the engine is typically set. During servicing life of the engine or the fuel pump, it may be necessary to remove the fuel pump from the engine for servicing or for installing replacement parts, upgraded parts, etc. The technicians are often expected to undertake a relatively laborious process of timing the fuel pump relative to the engine. One conventional strategy is to lock the fuel pump at a given orientation, remove the fuel pump from the engine, service the engine, then reinstall the fuel pump at the locked orientation.

U.S. Application Number 2009/0272366 discloses a method of setting up a common rail internal combustion engine system. The method includes setting a fuel pump for a common rail of the engine system at a configuration where a camshaft of the fuel pump is rotationally stable. The rotationally stable configuration may be a configuration where forces acting on the camshaft are balanced. The engine may then be set in an engine timing state which is accordant with the pump configuration, and the pump installed on the engine when in its first configuration and when the engine is at the engine timing state. The pump may be designed such that it has an installation assist mechanism which obviates the need for specialized tools or set up strategies to install the fuel pump on the engine with a correct timing.

### SUMMARY

In one aspect, a method of assembling a fuel pump on an engine is disclosed. A timing pin is installed between a pump flange of the fuel pump and a flywheel housing of the engine. The pump flange of the fuel pump is moved towards the flywheel housing of the engine. The timing pin is further removed which is installed between the pump flange and the flywheel housing of the engine. Further, the pump flange of the fuel pump is abutted with the flywheel housing of the engine.

In another aspect, a fuel pump for an engine is disclosed. The fuel pump includes a pump flange configured to abut with a flywheel housing of the engine. A pump pilot diameter is configured to be coupled to the pump flange of the fuel pump. The pump pilot diameter includes a slot configured to receive a timing pin between the pump flange of the fuel pump and the flywheel housing of the engine. The timing pin is configured for locking the fuel pump in accordance with a pre-determined engine configuration while assembling the fuel pump on the engine.

Other features and aspects of this disclosure will be apparent from the following description and the accompanying drawings.

### BRIEF DESCRIPTION OF THE DRAWINGS

FIG. 1 illustrates a partially sectional view of an engine system including an engine and a fuel pump;

FIG. 2 illustrates a perspective view of a pump pilot diameter of the fuel pump;

FIG. 3 illustrates a perspective view of the pump pilot diameter with a timing pin;

FIG. 4 illustrates a perspective view of a camshaft of the fuel pump;

FIG. 5 illustrates a method of fuel pump assembly onto the engine; and

FIGS. 6 to 8 illustrate a sectional side view of fuel assembly on the engine in accordance with the method of FIG. 5;

### DETAILED DESCRIPTION

The present disclosure relates to a fuel pump for an engine and a method of assembling the fuel pump on the engine. References will now be made in detail to specific embodiments or features, examples of which are illustrated in the accompanying drawings. Generally, corresponding reference numbers will be used throughout the drawings to refer to the same or corresponding parts.

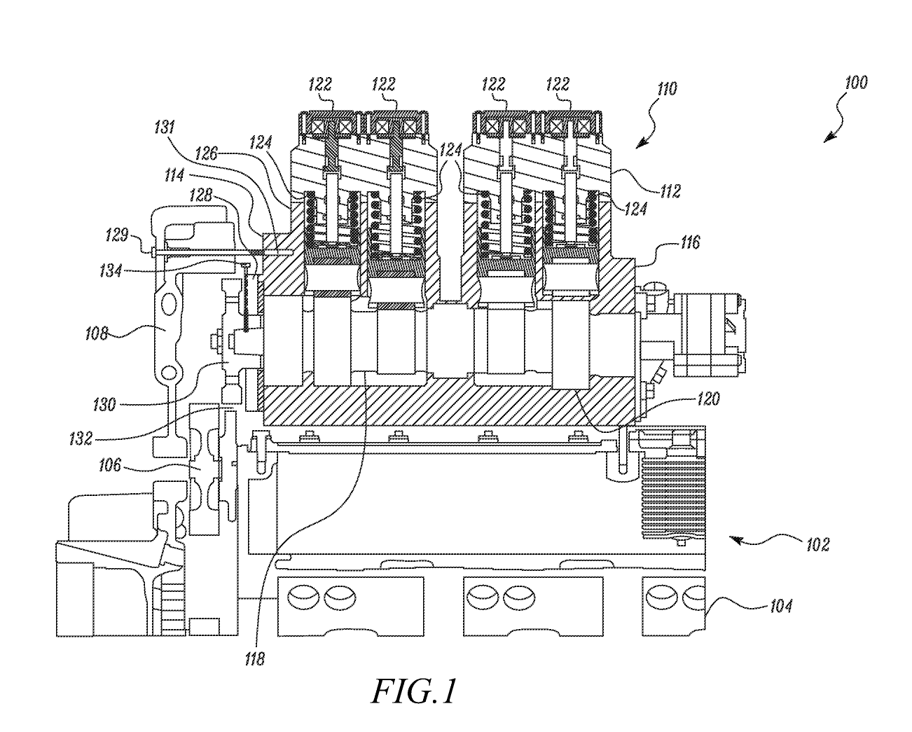

FIG. 1 illustrates an engine system 100, according to an exemplary embodiment of the present disclosure. In one embodiment, the engine system 100 may include a direct injection compression ignition diesel engine system. In other embodiments, the engine system 100 may be, but not limited to, spark ignited engine system, port injected engine system, or other engine system configuration. The engine system 100 includes an internal combustion engine 102 having an engine block 104 with a plurality of cylinders therein. A plurality of pistons may be associated with each of cylinders and configured to reciprocable therein. Each of the pistons may be coupled with a crankshaft which is in turn coupled with a driving gear 106 in a conventional manner. The engine system 100 may further include a flywheel housing 108 attached to the engine block 104 by using a known attachment means, such as bolting or welding or similar fastening means. The flywheel housing 108 may house the driving gear 106 and other gears of the engine 102. The engine system 100 may include a fuel pump 110 for the engine 102. The fuel pump 110 may be connected to a fuel supply system (not shown). The fuel supply system may further include a common rail which receives pressurized fuel from the fuel pump 110, and supplies pressurized fuel to each of cylinders of the engine 102.

In an aspect of the present disclosure, the fuel pump 110 may be a high pressure fuel pump. The fuel pump 110 includes a fuel pump housing 112 having a first end 114 and a second end 116. A camshaft 118 may extend from the first end 114 to the second end 116 of the fuel pump housing 112. Further, the camshaft 118 may include at least one set of cam lobes 120 that are spaced apart along the length of camshaft 118. The cam lobes 120 are spaced apart along the length of camshaft 118 may correspond with each of plunger assemblies 122 is configured to reciprocate in the fuel pump housing 112. The fuel pump housing 112 may further include a resilient member 124 configured to bias the plunger assemblies 122 towards the camshaft 118. In various alternative embodiments, each set of cam lobes 120 may include a single cam lobe, two cam lobes, three cam lobes, or more than three cam lobes. Although the fuel pump 110 illustrated as an inline plunger or piston pump in the present disclosure, those skilled in the art may understand that fuel pump may be such as, but not limited to, axial piston pump, radial piston pump, bent axis pump, inlet metered pump, outlet metered pump and with any one of a variety of different fluids (e.g., fuel, oil, hydraulic fluid, etc.).

The fuel pump 110 may include a pump flange 126 attached to the first end 114 of the fuel pump housing 112. Further, a pump pilot diameter 128 is coupled to the pump flange 126 by any known means known in the art. The pump pilot diameter 128 is coupled to the pump flange 126 by a mechanical fastening means, such as, but not limited to, bolting. According to an aspect of the present disclosure, the camshaft 118 may extend through the fuel pump housing 112 and the pump pilot diameter 128 at the first end 114 of the fuel pump housing 112. The fuel pump 110 may include a pump pilot gear 130, supported on the camshaft 118. During assembly, the pump flange 126 of the fuel pump 110 may be configured to abut with the flywheel housing 108 of the engine 102 such that the pump pilot diameter 128 is configured to be received in a bore 132 provided in the flywheel housing 108. Further, the pump pilot gear 130 supported on the camshaft 118 is configured to mesh with the driving gear 106 disposed within the flywheel housing 108 of the engine 102. The rotational motion of the driving gear 106 may be transferred to drive the pump pilot gear 130, which may further drive the fuel pump 110. As should be appreciated, the driving gear 106 and the pump pilot gear 130 may be atleast one of the spur gear, helical gear, and bevel gear. A person ordinarily skilled in the art may understand that, the flywheel housing 108 of the engine may further include other gears, including cam gear, crank gear or idler gears, which may drive rotation of various engine components and accessories, such as, for example, hydraulic and lubricating oil pumps.

In an aspect of the present disclosure, prior to assembly of the fuel pump 110 on the engine 102, the engine 102 may be fixed to a pre-determined engine configuration. The fuel pump may be locked with a pre-determined pump configuration relative to the pre-determined engine configuration. In an aspect of the present disclosure, the pre-determined pump configuration is top dead centre (TDC) in a reference plunger assembly 122 (for example plunger number 1) of the fuel pump 110 may be locked about 12 degrees before top dead center (TDC) in a reference cylinder (for example cylinder number 1) of the engine 102. Further, the pre-determined engine configuration may be varied based on a size of the engine 102 and other operating parameters. Further, the pump flange 126 of the engine 102 is aligned the flywheel housing 108 of the engine 102 such that pump pilot diameter 128 is aligned with the bore 132 of the flywheel housing 108. The pump flange 126 may include openings 131 for receiving a portion of an alignment pin 129 in the flywheel housing 108. During assembly of the fuel pump 110 on the engine 102, a timing pin 134 may be installed between the pump flange 126 of the fuel pump 110 and the flywheel housing 108 of the engine 102. The assembly further includes moving the pump flange 126 towards the flywheel housing 108 so that the pump pilot gear 130 is meshed with the driving gear 106. Further, the timing pin 134 may be removed before abutting the pump flange 128 of the fuel pump 110 on the flywheel housing 108 of the engine 102. Further, the alignment pins 129 may be completely received in the openings 131 in the pump flange 126.

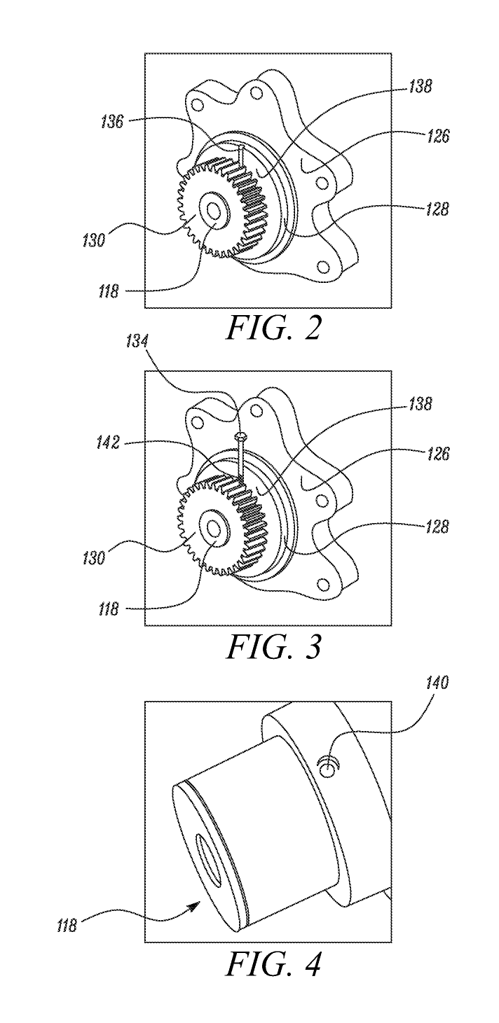

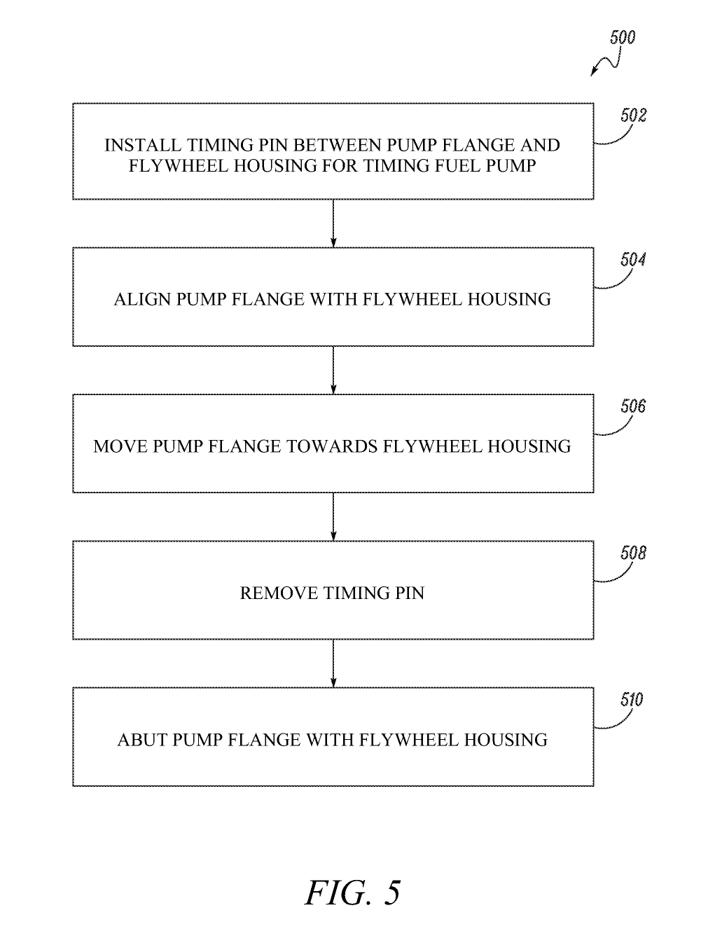

FIG. 2 illustrates a perspective view of the pump pilot diameter 128, according to an aspect of the present disclosure. The pump pilot diameter 128 may include a slot 136 machined onto its surface 138. In an embodiment of the present disclosure, the slot 136 may be of different cross-sections, such as, but not limited to, semi-circular, V-shape, U-shape. The slot 136 may be configured to receive the timing pin 134, as shown in FIG. 3. In alternative embodiments, plurality of slots may be provided on the surface 138 of the pump pilot diameter 128 for receiving various timing pins. In another alternative embodiment, a circular opening or hole may be provided in the pump pilot diameter 128 for receiving the timing pin 134.

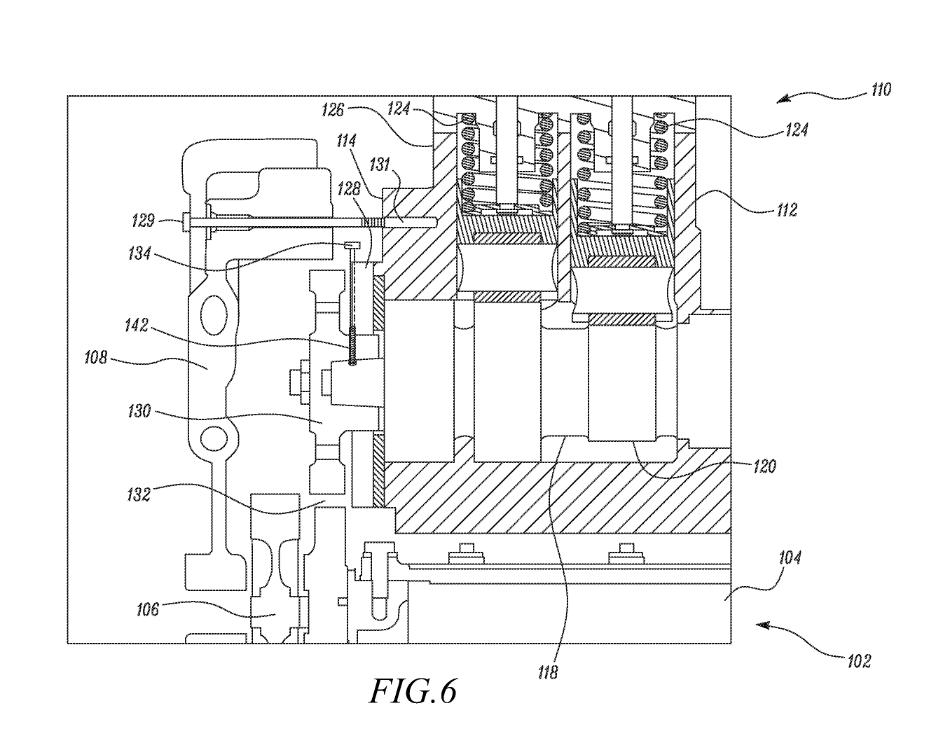

FIG. 4 illustrates a perspective view of the camshaft 118, according to an embodiment of the present disclosure. The camshaft 118 may be of a predetermined diameter and may extend through an inner bore of the pilot pump diameter 128. The camshaft 118 may define a recess or hole 140 configured to receive a distal end of the timing pin 134 into the recess 140, positioned within the slot 136 of the pump pilot diameter 128 for locking rotation of the camshaft 118. Further, the recess 140 provided on the camshaft 118 may be positioned at a pre-defined angle relative to the cam lobe 120 of the fuel pump 110 (see FIG. 1) thereby providing a fixed orientation of the fuel pump 110 relative to the camshaft 118.

In an aspect of the present disclosure, the recess 140 provided on the camshaft 118 of the fuel pump 110 may be a threaded hole. The timing pin 134 received into the threaded hole may be a bolt, so that external threads 142 (see FIG. 3) provided on the bolt 134 are configured to securely engage into internal threads within the recess 140 provided in the camshaft 118. The bolt 134 may be configured for engagement with the threaded recess 140 by tightening with a wrench or a drill. A person ordinarily skilled in the art may understand that, the bolt 134 may conform to any of the industrial standards known in the art. In an aspect of the present disclosure, the bolt 134 may be a hex head bolt of defined industrial standards. The bolt 134 may be formed from various materials, such as, but not limited to, carbon steel bolt, alloy steel bolt, zinc plated bolt, galvanized hex bolt, etc. In an alternative embodiment, the recess 140 may extend through the camshaft 118 so that external threads 142 provided on the distal end of the bolt 134 may be fastened onto the camshaft 118 by any mechanical means, such as, but not limited to, a nut.

### INDUSTRIAL APPLICABILITY

The present disclosure may be applicable to internal combustion engines having common rail fuel systems. Further, the present disclosure may be particularly applicable to locking a fuel pump to a pre-determined pump configuration relative to a pre-determined engine configuration. The fuel pump may need to orient pumping events to engine firing events to minimize gear train dynamics and noise.

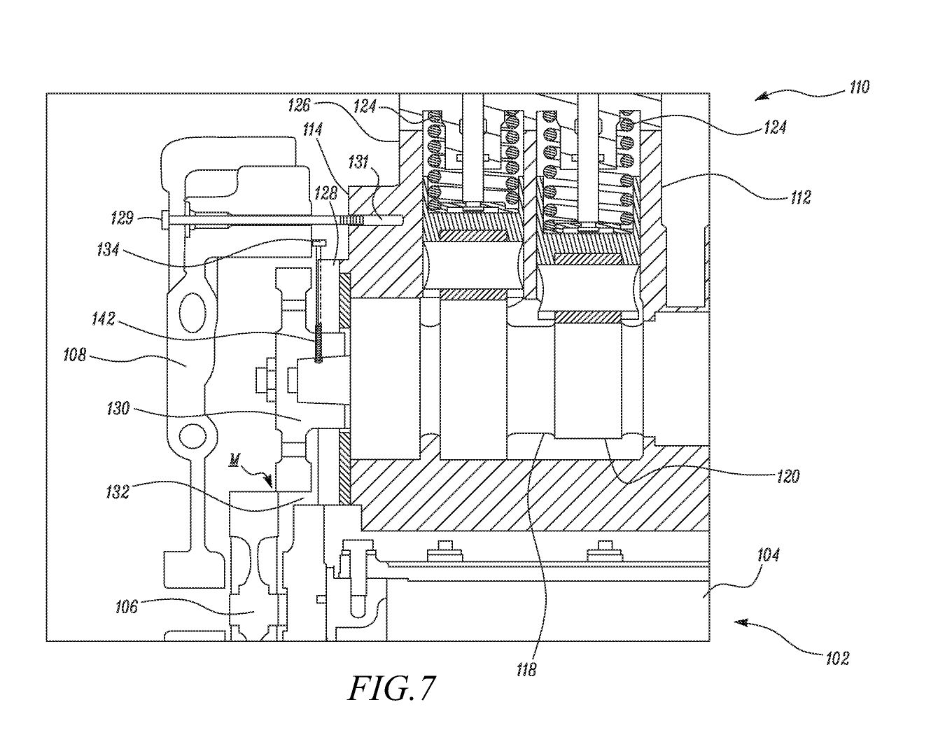

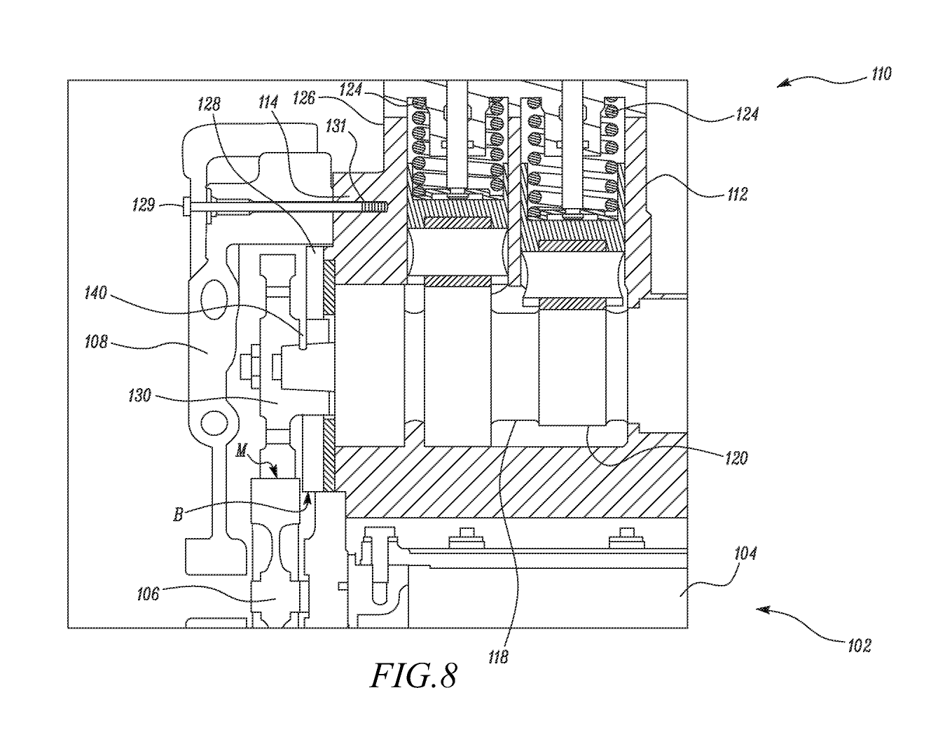

FIG. 5 illustrates a method 500 for assembling the fuel pump 110 on the engine 102 in combination with FIGS. 6, 7 and 8. At step 502, the timing pin 134 is installed between the pump flange 126 and the flywheel housing 108 for timing the fuel pump 110 in accordance with the pre-determined engine configuration. The timing pin 134 is received through the slot 136 provided in the pump pilot diameter 128 and fastening the distal end of the timing pin 134 into the recess 140 on the camshaft 118 may lock the rotation of the camshaft 118 in accordance with the predetermined engine configuration so that the cam lobes provided along the length of the camshaft 118 are arranged in a specific orientation relative to the fuel pump 110. Further, at step 504, the pump flange 126 of the fuel pump 110 is aligned with the flywheel housing 108 of the engine 102. The alignment pins 129 received in the openings 131 of the pump flange may align pump pilot diameter 128 coupled to the pump flange 126 within the bore 132 provided in the flywheel housing 108, as shown in FIG. 6.

In an aspect of the present disclosure, the external threads 142 provided on the distal end of the timing pin 134 may be fastened into the internal threads of recess 140 on the camshaft 118 ensures accurate after assembly of the fuel pump 110 at the factory. The fuel pump 110 is properly oriented and the timing pin is threaded into the camshaft 118 to lock the fuel pump in the pre-determined pump configuration in accordance with the pre-determined engine configuration. Further, the timing pin 134 received in the recess 140 of the camshaft 118 may not fall out during shipment of the fuel pump 110 to the engine factory. In an embodiment of the present disclosure, the timing pin 134 is a standard M6X1 bolt, which is readily available at relatively low cost.

Further, at step 506, the pump flange 128 may be moved towards the flywheel housing 108 of the engine 102 includes meshing the pump pilot gear 130 supported on the camshaft 118 with the driving gear 106 disposed within the flywheel housing 108, as shown by M in FIG. 7. Further, at step 508, the timing pin 134 is removed from the pump pilot diameter 128 which may allow the rotation of the camshaft 118 and abutting of the fuel pump 110 on the engine 102. Further, at step 510, the pump flange 128 of the fuel pump 110 may be abutted with the flywheel housing 108 of the engine 102 includes receiving the pump pilot diameter 128 within the bore 132 in the flywheel housing 108, as shown by B in FIG. 8. At this point the pump pilot gear 130 is fully meshed with the driving gear 106, as shown by M.

The present disclosure minimizes the probability of the timing pin being left in a locked position in the fuel pump, once the fuel pump is installed on the engine and the engine is first started, which may result in the fuel pump or engine gear train being damage. Further, if the fuel pump is removed from the engine in the field, it may need to be re-timed to the engine prior to being re-installed. A timing pin may need to be procured by a service technician to re-time the fuel pump. The present disclosure addresses the need for a low cost and simple installation mechanism to mount the fuel pump onto the engine with setting the timing between the fuel pump and the engine during installation. The present disclosure also eliminates the need to provide a port to the fuel pump housing to receive the timing pin, which may increase cost.

Further, timing pins are often product specific components which may be expensive and add additional leak paths for oil (or fuel) which leaks externally on the engine. By using a common bolt as the timing pin in combination with a slot on the pilot diameter and recess in the camshaft, these issues may be mitigated.

In an aspect of the present disclosure, the required removal of the timing pin 134 before abutment to the flywheel housing 108 reduces the risk of damage to the engine 102 and fuel pump 110 from attempting to rotate a “locked” fuel pump 110 on the engine 102. Further, the fuel pump 110 may not able to be abutted on the engine 102 without removing the timing pin 134 so that the gear train damage may be avoided. In an aspect of the present disclosure, the fuel pump 110 may be re-timed in the field can be visual, and can be done with readily available tools and bolt and may be easier to service in a field. The timing pin 134 received in the recess 140 of the camshaft 118 may not require additional seals/O-rings ensuring no leakage path from the fuel pump 110 onto the engine 102.

It will be apparent to those skilled in the art that various modifications and variations can be made to the disclosed method of assembling fuel pump on the engine without departing from the scope of the disclosure. Other embodiments of the present disclosure will be apparent to those skilled in the art from consideration of the specification and practice of the system disclosed herein. It is intended that the specification and examples be considered as exemplary only, with a true scope of the disclosure being indicated by the following claims and their equivalents.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A method for assembling a fuel pump on an engine, the method comprising:
installing a timing pin between a pump flange of the fuel pump and a flywheel housing of the engine;
moving the pump flange towards the flywheel housing;
removing the timing pin; and
abutting the pump flange and the flywheel housing of the engine.

2. The method of claim 1, further comprising fixing the engine at a pre-determined engine configuration and aligning the pump flange with the flywheel housing.

3. The method of claim 1, wherein timing the fuel pump comprising locking a rotation of a camshaft extending through a pump pilot diameter coupled to the pump flange.

4. The method of claim 3, wherein the locking rotation of the camshaft comprising receiving the timing pin through a slot provided in the pump pilot diameter and fastening a distal end of the timing pin into a recess provided on the camshaft.

5. The method of claim 4, wherein the fastening the distal end of the timing pin into the recess on the camshaft comprising threaded fastening.

6. The method of claim 3, wherein moving the pump flange towards the flywheel housing comprises meshing a pump pilot gear supported on the camshaft with a driving gear disposed within the flywheel housing.

7. The method of claim 3, wherein the removing the timing pin comprises allowing the rotation of the camshaft.

8. The method of claim 3, wherein abutting the pump flange and the flywheel housing comprises receiving the pump pilot diameter within the bore in the flywheel housing.

9. A fuel pump for an engine, the fuel pump comprising:
a pump flange configured to abut a flywheel housing of the engine;
a pump pilot diameter coupled to the pump flange; and
a slot provided on the pump pilot diameter, the slot configured to receive a timing pin for locking the fuel pump in accordance with a pre-determined engine configuration while assembling the fuel pump on the engine.

10. The fuel pump of claim 9 further comprising:
a camshaft extending through the pump pilot diameter; and
a recess provided on the camshaft wherein the recess is configured to fasten a distal end of the timing pin into the recess for locking a rotation of the camshaft.

11. The fuel pump of claim 10, wherein the recess provided on the camshaft is positioned at a pre-defined angle relative to a cam lobe.

12. The fuel pump of claim 9, wherein the pump pilot diameter is configured to be received within a bore provided in the flywheel housing.

13. The fuel pump of claim 9 further comprising a pump pilot gear supported on the camshaft, the pump pilot gear configured to mesh with a driving gear disposed within the flywheel housing.

14. A method for assembling a fuel pump on an engine, the method comprising:
fixing the engine at a pre-determined engine configuration;
installing a bolt between a pump flange and a flywheel housing for locking the fuel pump with a pre-determined pump configuration relative to the pre-determined engine configuration;
aligning the pump flange of the fuel pump and the flywheel housing of the engine;
moving the pump flange towards the flywheel housing;
removing the bolt; and
abutting the pump flange and the flywheel housing of the engine.

15. The method of claim 14, wherein aligning the pump flange and the flywheel housing comprises aligning a pump pilot diameter coupled to the pump flange with a bore provided in the flywheel housing.

16. The method of claim 15, wherein locking the fuel pump comprises locking a rotation of a camshaft extending through the pump pilot diameter.

17. The method of claim 16, wherein the locking rotation of the camshaft comprises receiving the bolt through a slot provided in the pump pilot diameter and thread fastening a distal end of the bolt into a threaded hole provided on the camshaft.

18. The method of claim 16, wherein moving the pump flange towards the flywheel housing comprises meshing a pump pilot gear supported on the camshaft with a driving gear disposed within the flywheel housing.

19. The method of claim 16, wherein the removing the bolt comprises allowing the rotation of the camshaft.

20. The method of claim 15, wherein the abutting the pump flange and the flywheel housing comprises receiving the pump pilot diameter within the bore in the flywheel housing.
